(19) United States
(12) Patent Application Publication
(10) Pub. No.: US 2025/0061304 A1
(43) Pub. Date: Feb. 20, 2025

(54) METHODS AND SYSTEMS FOR TEMPORAL GRAPH REPRESENTATION LEARNING BASED ON NODE-LEVEL TEMPORAL POINT PROCESSES

(71) Applicant: MASTERCARD INTERNATIONAL INCORPORATED, Purchase, NY (US)

(72) Inventors: Govind Vitthal WAGHMARE, Pune (IN); Ankur ARORA, New Delhi (IN); Pritam Kumar NATH, Kolkata (IN); Siddhartha ASTHANA, New Delhi (IN)

(73) Assignee: MASTERCARD INTERNATIONAL INCORPORATED, Purchase, NY (US)

(21) Appl. No.: 18/807,667

(22) Filed: Aug. 16, 2024

(30) Foreign Application Priority Data
Aug. 18, 2023 (IN) 202341055709

(51) Int. Cl. G06N 3/042

(52) U.S. Cl. CPC G06N 3/042

(57) ABSTRACT

Embodiments provide methods and systems for temporal graph representation learning based on node-level temporal point processes. Method performed by the server system includes accessing historical interaction data, generating temporal graph based on historical transaction data and predicting likelihoods of future interaction occurrences among entities based on a pre-trained TPP based graph neural network (GNN) model. Method includes determining edge embeddings of each node based on node features of each node and direct neighbor nodes of each node. Method includes generating edge-contextualized node embeddings of each node corresponding to the edge embeddings based on a neural network model and computing a likelihood of future interaction occurrences associated with the each node based on edge-contextualized node embeddings and a conditional intensity function. Method includes executing at least one of a plurality of graph context prediction tasks based on likelihoods of future interaction occurrences among entities.

### TECHNICAL FIELD

The present disclosure relates to node representation learning systems and, more particularly to, electronic methods and complex processing systems for graph representation learning for temporal graphs based on node-level temporal point processes (TPP) based graph neural network (GNN) model, to perform a plurality of graph context prediction tasks.

### BACKGROUND

Many temporal events in the real world are interactions between different entities. These dynamic interactions evolve and have diverse relationships with each other. Temporal graphs are a suitable mathematical abstraction to describe these dynamics between entities. Such temporal graphs are used to represent data relationships between different types of entities in various domains, such as payment networks (for example, user-merchant transactions), e-commerce (for example, user-product temporal interaction graph), and the like.

The temporal graph representation models learn effective ways to represent evolving node information. It has applications in vast domains like finance, commerce and retail, social networks, etc. Major tasks associated with temporal graphs are community detection, graph classification, node classification, and temporal link prediction. A temporal graph dataset consists of a chronological sequence of edges. Each temporal edge defines an interaction between two nodes.

To extract effective information from any temporal graph, learning representations (e.g., embeddings) of nodes is an important and ubiquitous task. In general, representation learning refers to the ability to learn complex relations between the different entities of the temporal graph from a high-dimensional graph structure to a low-dimensional dense vector (i.e., embeddings). The learned representations (i.e., embeddings) may further be used to perform tasks such as link prediction, analysis, and so on. However, to extract effective information from the temporal graph, there are a few limitations in the existing approaches.

In general, based on the time aspect, there are two broad ways in which graphs are represented: (1) static and (2) temporal. Within static methods, existing works study network embeddings (based on random walks) and GNN-based. When temporal order of sequence is important, temporal graph representation methods are required. For any particular node, any temporal graph representation method observes the sequence of incident edges in the past. These past interactions of the node are asynchronous temporal events localized in continuous time. Typical temporal graph representation methods fail to capture the evolutionary characteristics of the event sequence.

The temporal graph representation methods include discrete-time and continuous-time representation methods. The discrete-time-based methods create temporal snapshots of the temporal graph and are incapable of modeling temporal dynamics across snapshots. Similarly, some of the continuous-time temporal representation methods do not consider the use of temporal point processes (TPPs) to model excitation and the influence of past events on current events. Additionally, the training objective for temporal link prediction with the existing models focuses only on the current edge instead of the past edge sequence, missing edge context information.

In view of the above discussion, there exists a technological need to implement a flexible and efficient TPP-based GNN model for temporal graph representation learning.

### SUMMARY

Various embodiments of the present disclosure provide methods and systems for temporal graph representation learning based on node-level point processes.

In an embodiment, a computer-implemented method is disclosed. The method includes accessing, by a server system, historical interaction data including a plurality of interactions from a database. The method further includes generating, by the server system, a temporal graph based, at least in part, on the historical interaction data. The temporal graph represents a computer-based graph representation of the plurality of entities as nodes and time-ordered event sequences between nodes as temporal edges. The method includes predicting the likelihoods of future interaction occurrences among the plurality of entities based, at least in part, on a pre-trained temporal point process (TPP) based graph neural network (GNN) model. The likelihoods of future interaction occurrences are determined by executing a plurality of operations for each node in a graph traversal manner. The plurality of operations include determining, by the server system, a plurality of edge embeddings associated with a node based, at least in part, on node features of the node and a plurality of direct neighbor nodes of the node. The plurality of operations includes generating, by the server system, edge-contextualized node embeddings of the node corresponding to the plurality of edge embeddings based, at least in part, on a neural network model. The plurality of operations further includes computing, by the server system, a likelihood of future interaction occurrences associated with the node based, at least in part, on the edge-contextualized node embeddings and a conditional intensity function. Moreover, the method includes executing, by the server system, at least one of a plurality of graph context prediction tasks based, at least in part, on the likelihoods of future interaction occurrences among the plurality of entities.

In another embodiment, a server system is disclosed. The server system includes a communication interface and a memory including executable instructions. The server system also includes a processor communicably coupled to the memory. The processor is configured to execute the instructions to cause the server system, at least in part, to access historical interaction data including a plurality of interactions from a database, and generate a temporal graph based, at least in part, on the historical interaction data. The temporal graph represents a computer-based graph representation of the plurality of entities as nodes and time-ordered event sequences between nodes as temporal edges. Further, the server system is caused to predict likelihoods of future interaction occurrences among the plurality of entities based, at least in part, on a pre-trained temporal point process (TPP) based graph neural network (GNN) model. The likelihoods of the future interaction occurrences are determined by executing a plurality of operations for each node in a graph traversal manner. The plurality of operations include the determination of a plurality of edge embeddings associated with a node based, at least in part, on node features of the node and a plurality of direct neighbor nodes of the node. The plurality of operations further includes generation of edge-contextualized node embeddings of the node corresponding to the plurality of edge embeddings based, at least in part, on a neural network model. The plurality of operations furthermore includes computation of a likelihood of future interaction occurrences associated with the node based, at least in part, on the edge-contextualized node embeddings and a conditional intensity function. Moreover, the server system is caused to execute at least one of a plurality of graph context prediction tasks based, at least in part, on the likelihoods of future interaction occurrences among the plurality of entities.

In yet another embodiment, a non-transitory computer-readable storage medium is disclosed. The non-transitory computer-readable storage medium includes computer-executable instructions that, when executed by at least a processor of a server system, cause the server system to perform a method. The method includes accessing historical interaction data including a plurality of interactions from a database. The method further includes generating a temporal graph based, at least in part, on the historical interaction data. The temporal graph represents a computer-based graph representation of the plurality of entities as nodes and time-ordered event sequences between nodes as temporal edges. The method includes predicting likelihoods of future interaction occurrences among the plurality of entities based, at least in part, on a pre-trained temporal point process (TPP) based graph neural network (GNN) model. The likelihoods of the future interaction occurrences are determined by executing a plurality of operations for each node in a graph traversal manner. The plurality of operations include determining a plurality of edge embeddings associated with a node based, at least in part, on node features of the node and a plurality of direct neighbor nodes of the node. The plurality of operations includes generating edge-contextualized node embeddings of the node corresponding to the plurality of edge embeddings based, at least in part, on a neural network model. The plurality of operations further includes computing a likelihood of future interaction occurrences associated with the node based, at least in part, on the edge-contextualized node embeddings and a conditional intensity function. Moreover, the method includes executing at least one of a plurality of graph context prediction tasks based, at least in part, on the likelihoods of future interaction occurrences among the plurality of entities.

Other aspects and example embodiments are provided in the drawings and the detailed description that follows.

### BRIEF DESCRIPTION OF THE FIGURES

For a more complete understanding of example embodiments of the present technology, reference is now made to the following descriptions taken in connection with the accompanying drawings in which:

FIG. 1A illustrates an exemplary representation of an environment related to at least some embodiments of the present disclosure;

FIG. 1B illustrates another exemplary representation of an environment related to at least some embodiments of the present disclosure;

FIG. 2 illustrates a simplified block diagram of a server system, in accordance with an embodiment of the present disclosure;

FIGS. 3A-3C depict example representations of predicting future interactions between a source node and a target node in a given temporal network, in accordance with an embodiment of the present disclosure;

FIGS. 4A and 4B are block diagram representations of node-level temporal point process (TPP) based GNN model (i.e., NodeTPP model), in accordance with an embodiment of the present disclosure;

FIG. 5 illustrates a flow diagram depicting a method for training the NodeTPP model, in accordance with an embodiment of the present disclosure;

FIG. 6 illustrates a flow diagram depicting a method for temporal graph representation learning based on temporal point processes, in accordance with an embodiment of the present disclosure;

FIG. 7A is a table including hyperparameters associated with NodeTPP model;

FIGS. 7B and 7C show comparative results of the performance of the NodeTPP model and the other comparative algorithms on the above stated temporal task prediction task; and

FIGS. 8A-8C depict an ablation study of the NodeTPP model by comparing the NodeTPP model with baseline models.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details.

Reference in this specification to “one embodiment” or “an embodiment” means that a particular feature, structure, or characteristic described in connection with the embodiment is included in at least one embodiment of the present disclosure. The appearance of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

The term “payment network”, used herein, refers to a network or collection of systems used for the transfer of funds through the use of cash substitutes. Payment networks may use a variety of protocols and procedures to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, financial accounts, etc. Examples of networks or systems configured to perform as payment networks include those operated by such as Mastercard®.

The term “merchant”, used throughout the description generally refers to a seller, a retailer, a purchase location, an organization, or any other entity that is in the business of selling goods or providing services, and it can refer to either a single business location or a chain of business locations of the same entity.

The terms “cardholder”, “user”, and “customer” are used interchangeably throughout the description and refer to a person who holds a credit or a debit card that will be used by a merchant to perform a payment transaction.

The terms “embeddings” and “vector representations” are used interchangeably throughout the description and refer to a low-dimensional state or space in which high-dimensional vectors can be translated. More specifically, embeddings make it easier to perform machine learning analysis on high-dimensional vector formats. In some embodiments, vector representations can include vectors that represent nodes from graph data in a vector space. In some embodiments, vector representations can include embeddings.

### OVERVIEW

Various embodiments of the present disclosure provide methods, systems electronic devices, and computer program products for graph representation learning for temporal graphs.

A temporal graph is a mathematical abstraction to model diverse relationships between multiple nodes and how their interactions evolve. Temporal graph representation learning aims to learn effective node embeddings. These representations should be over continuous time, inductive for nodes unseen in the training, and capable of understanding how edges contribute to neighborhood formation. Temporal edges incident on the nodes in the graph can be viewed as discrete events localized in continuous time. A well-known generative probabilistic mathematical framework to model continuous-time event sequences is temporal point processes (TPP). Previous Hawkes-based GNN methods have several trade-offs due to simple parametrization of the intensity function. Additionally, the existing methods that use TPP (with or without GNN) focus on learning only the Hawkes-process-based conditional intensity function which is not flexible and efficient. Further, the training objective of the temporal link prediction focuses on current edges instead of past edge sequences, thus missing edge context.

To overcome such limitations, the present disclosure describes a method to learn the structural and relational properties of the graph using graph neural network (GNN) and temporal event dynamics using TPP at node-level, called NodeTPP model. The present disclosure describes learning of neighborhood aggregation using a more flexible neural TPP model based on a sophisticated intensity function. Neural TPPs are capable of modeling non-linear dynamics between entities. The model is optimized based on the likelihood of the sequence, instead of approximating just the next edge probability through the softmax function, as done in the prior works. Edge context is the key to edge and node dynamics. The NodeTPP model learns node dynamics by conditioning nodes on past edge sequences forming edge-contextualized node embeddings. While modeling the current edge dynamics from source and target nodes, the NodeTPP model focuses on incident edge sequences on the nodes to learn edge-contextualized node embeddings. During training, the influence of past events is modeled by optimizing the inter-edge density of the past edge sequence. Thus, the present disclosure describes learning hidden information or hidden representations of nodes that explicitly capture temporal interactions with neighbor nodes while implicitly retaining information from self-features of the node.

In an embodiment, the present disclosure describes a server system for temporal graph representation learning to perform a plurality of graph context prediction tasks. In one embodiment, the server system may be a payment server associated with a payment network. The server system includes a processor and memory. The server system is configured to access historical interaction data including a plurality of interactions among a plurality of entities from a database. Based on the historical interaction data, the server system is configured to generate a temporal graph. The temporal graph represents a computer-based graph representation of the plurality of entities as nodes and time-ordered event sequences between nodes as temporal edges. In one embodiment, the plurality of entities includes a first set of entities and a second set of entities. The first set of entities includes a plurality of cardholders and the second set of entities includes a plurality of merchants. The historical interaction data may further represent payment transactions performed between the cardholders and the merchants, product purchases between the users and the products, connections depicting ownership between the authors and the books, and the like. In one embodiment, the historical interaction data accessed from the database may include data of payment transactions performed between the plurality of cardholders and the plurality of merchants over a time period (e.g., 1 month, 3 months, 2 years, 5 years, etc.).

The server system is configured to predict the likelihoods of future interaction occurrences among the plurality of entities based, at least in part, on a pre-trained temporal point process (TPP) based graph neural network (GNN) model (i.e., NodeTPP model). The likelihoods of future interaction occurrences are determined by executing a plurality of operations for each node in a graph traversal manner.

In one embodiment, the server system is configured to determine a plurality of edge embeddings associated with each node based, at least in part, on node features of the each node and a plurality of direct neighbor nodes of the each node. The plurality of edge embeddings defines an incident edge sequence corresponding to the each node. The server system is configured to concatenate the node features of the each node and the plurality of direct neighbor nodes of the each node based, at least in part, on the time of interactions between the each node and the plurality of direct neighbor nodes.

Thereafter, the server system is configured to generate edge-contextualized node embeddings of the each node corresponding to the plurality of edge embeddings based, at least in part, on a neural network model. In one example, the neural network model is a recurrent neural network model. Based on the edge-contextualized node embeddings, the server system is configured to calculate a conditional intensity for each edge of the each node and calculate a likelihood function based on the conditional intensity of each edge, wherein the likelihood function is conditioned on edges of the each node. Thus, based on the likelihood function, the server system is configured to compute a likelihood of future interaction occurrences associated with the each node. It is important to note that this process is performed for all nodes as well in the temporal graph.

Based on the likelihoods of future interaction occurrences, the server system is configured to execute at least one of a plurality of graph context prediction tasks. In one embodiment, the one or more applications and/or tasks include at least one of: (a) transaction anomaly detection, (b) dynamic edge prediction between cardholder and merchant, (c) anti-money laundering, and (d) behavior/pattern modeling (purchase behavior).

In one embodiment, the NodeTPP model is trained based, at least in part, on a combination of a first loss value and a second loss value at node-level. The NodeTPP model is trained in a self-supervised manner with an objective function that depends upon negative log-likelihood of temporal edge sequences incident on the node. The first loss value is based, at least in part, on negative log-likelihood (NLL) of the likelihood function determined based on conditional intensity of each edge. The second loss value is a node dynamics loss, wherein the node dynamics loss is determined based on smooth L1 loss.

Various embodiments of the present disclosure offer multiple advantages and technical effects. The proposed solution shows significant improvements in the four real-world datasets in predictive performance over previous temporal GNNs and Hawkes process-based GNN. Further, the present disclosure provides significantly more robust solutions because of handling simultaneous/concurrent processor execution (such as applying one or more neural network models over the same input, simultaneously). Even further, the present disclosure improves the operations of processors because, by performing these synergistic operations to determine node representations of temporal graphs that can be used for further downstream applications, the processors will require fewer computation cycles in learning node representations of the temporal graphs.

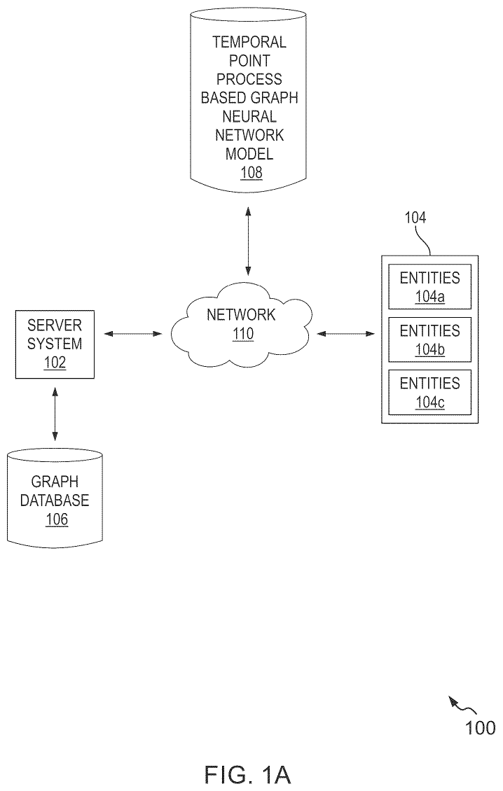

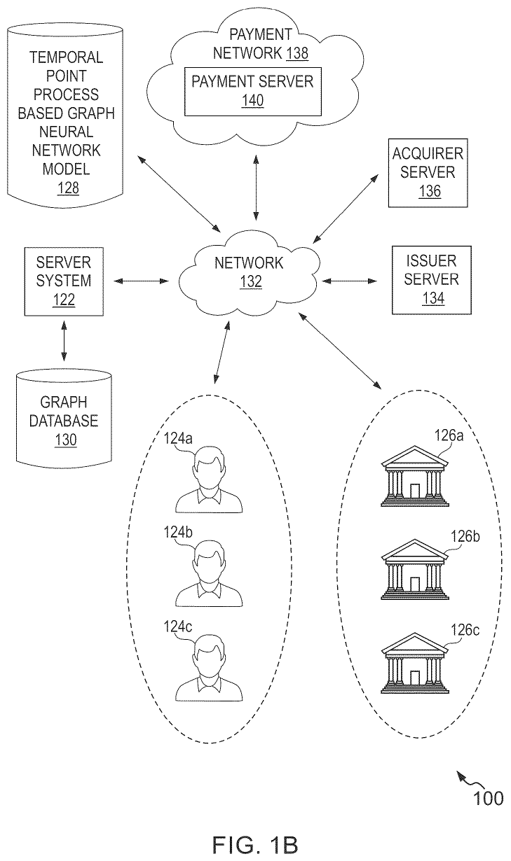

Various example embodiments of the present disclosure are described hereinafter with reference to FIGS. 1A-1B to 8A-8C.

FIG. 1A illustrates an exemplary representation of an environment 100 related to at least some embodiments of the present disclosure. Although the environment 100 is presented in one arrangement, other embodiments may include the parts of the environment 100 (or other parts) arranged otherwise depending on, for example, temporal graph representation learning for temporal graphs, etc. The environment 100 generally includes a server system 102, a plurality of entities 104a, 104b, and 104c, a graph database 106, and a temporal point process (TPP) based graph neural network (GNN) model 108, each coupled to, and in communication with (and/or with access to) a network 110. The network 110 may include, without limitation, a light fidelity (Li-Fi) network, a local area network (LAN), a wide area network (WAN), a metropolitan area network (MAN), a satellite network, the Internet, a fiber-optic network, a coaxial cable network, an infrared (IR) network, a radio frequency (RF) network, a virtual network, and/or another suitable public and/or private network capable of supporting communication among the entities illustrated in FIG. 1A, or any combination thereof.

Various entities in the environment 100 may connect to the network 110 in accordance with various wired and wireless communication protocols, such as Transmission Control Protocol and Internet Protocol (TCP/IP), User Datagram Protocol (UDP), 2nd Generation (2G), 3rd Generation (3G), 4th Generation (4G), 5th Generation (5G) communication protocols, Long Term Evolution (LTE) communication protocols, future communication protocols, or any combination thereof. For example, the network 110 may include multiple different networks, such as a private network made accessible by the network 110 to the server system 102, and a public network (e.g., the Internet, etc.).

The plurality of entities 104a-104c, but is not limited to, medical facilities (e.g., hospitals, laboratories, etc.), financial institutions, educational institutions, government agencies, and telecom industries. The plurality of entities 104a-104c may be associated (in some way or the other) or interact among themselves.

The server system 102 is configured to perform one or more of the operations described herein. The server system 102 is configured to perform temporal graph representation learning. The server system 102 is a separate part of the environment 100 and may operate apart from (but still in communication with, for example, via the network 110), the plurality of entities 104a-104c, and any third-party external servers (to access data to perform the various operations described herein). However, in other embodiments, the server system 102 may actually be incorporated, in whole or in part, into one or more parts of the environment 100, for example, the first entity 104a. In addition, the server system 102 should be understood to be embodied in at least one computing device in communication with the network 110, which may be specifically configured, via executable instructions, to perform as described herein, and/or embodied in at least one non-transitory computer-readable media.

The server system 102 is configured to access historical interaction data associated with the plurality of entities 104a-104c. The graph database 106 may store the interaction data including a plurality of interactions among the plurality of entities 104a-104c.

The term “interaction data” may include a reciprocal action. An interaction can include communication, contact, or exchange between parties, devices, and/or entities. Example interactions include a transaction between two parties and data exchange between two devices. In some embodiments, an interaction can include a user requesting access to secure data, a secure webpage, a secure location, and the like. In other embodiments, an interaction can include a payment transaction in which two devices can interact to facilitate payment.

The server system 102 is configured to generate a temporal graph based, at least in part, on the historical interaction data. In one embodiment, the server system 102 is configured to receive the temporal graph from the graph database 106. The graph database 106 is configured to store temporal graph data (e.g., topological graphs). In some embodiments, the graph database 106 may store a plurality of graph instances of a dynamic temporal graph. In some embodiments, the graph database 106 may be conventional, fault-tolerant, relational, scalable, secure databases such as those commercially available from third-party providers, etc. The temporal graph represents a computer-based graph representation of the plurality of entities as nodes and interactions among nodes as temporal edges. In one embodiment, the graph database 106 stores data associated with the temporal graph.

The plurality of entities 104a-104c may include heterogeneous or homogeneous entities. For example, the plurality of entities includes a first and second set of entities. The first set of entities represents a set of users, and the second set of entities represents a set of products listed on an e-commerce website or platform. The set of users includes users who have purchased at least one of the set of products listed on the e-commerce website. In addition, information associated with the set of users and the set of products is stored in the graph database 106. The set of users may be represented as the first nodes and the set of products may be represented as the second nodes. The edges may further exist between the first set of entities and the second set of entities for the set of users that may have purchased the set of products.

In another example, the first set of entities represents a set of authors, and the second set of entities represents a set of books. The set of authors may represent authors that have written or are creators of at least one of the set of books. In addition, information associated with the set of authors and the set of books is stored in the graph database 106. The set of authors may be represented as the first nodes and the set of books may be represented as the second nodes.

In one embodiment, the server system is configured to learn relational and structural properties based on graph neural network (GNN) and temporal event dynamics using temporal point processes (TPPs).

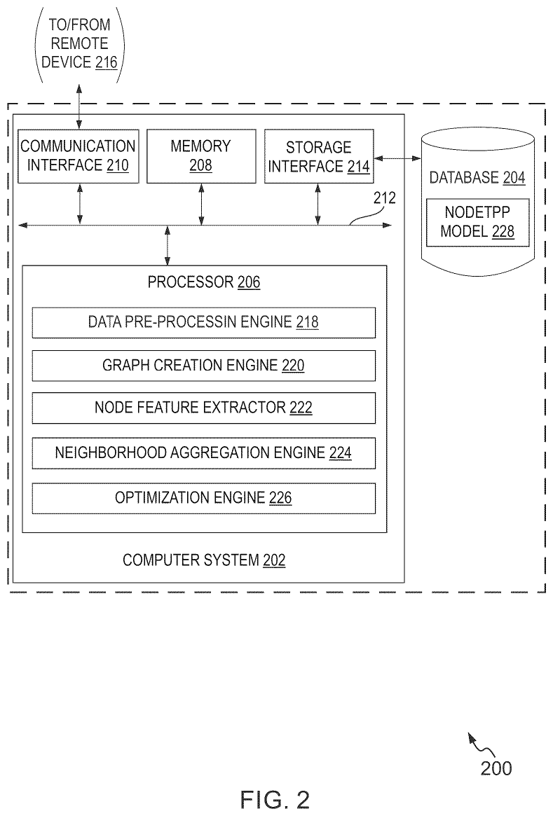

The server system 102 is configured to determine likelihoods of future event occurrences among the nodes based, at least in part, on node-level TPP based GNN model (interchangeably, used throughout the description as ‘NodeTPP model’). A detailed explanation for performing the plurality of operations is herein explained in detail with reference to FIG. 2, and therefore, it is not reiterated for the sake of brevity.

FIG. 1B illustrates another exemplary representation of an environment 120 related to at least some embodiments of the present disclosure. Although the environment 120 is presented in one arrangement, other embodiments may include the parts of the environment 120 (or other parts) arranged otherwise depending on, for example, temporal graph representation learning for transaction data, etc. The environment 120 generally includes a server system 122, a plurality of cardholders 124a, 124b and 124c, a plurality of merchants 126a, 126b and 126c, a temporal point process based GNN model 128 (interchangeably described as NodeTPP model), a graph database 130, an issuer server 134, an acquirer server 136, and a payment network 138 including a payment server 140, each coupled to, and in communication with (and/or with access to) a network 132. The network 132 may include, without limitation, a light fidelity (Li-Fi) network, a local area network (LAN), a wide area network (WAN), a metropolitan area network (MAN), a satellite network, the Internet, a fiber-optic network, a coaxial cable network, an infrared (IR) network, a radio frequency (RF) network, a virtual network, and/or another suitable public and/or private network capable of supporting communication among the entities illustrated in FIG. 1B, or any combination thereof.

Various entities in the environment 120 may connect to the network 132 in accordance with various wired and wireless communication protocols, such as Transmission Control Protocol and Internet Protocol (TCP/IP), User Datagram Protocol (UDP), 2nd Generation (2G), 3rd Generation (3G), 4th Generation (4G), 5th Generation (5G) communication protocols, Long Term Evolution (LTE) communication protocols, or any combination thereof. For example, the network 132 may include multiple different networks, such as a private network made accessible by the network 132 to the server system 122, and a public network (e.g., the Internet, etc.).

In one embodiment, the plurality of cardholders 124a-124c may include a list of cardholders that may have performed a payment transaction through a payment instrument (e.g., payment card, payment wallet, payment account, etc.) at the plurality of merchants 126a-126c. In one embodiment, the payment account of the plurality of cardholders 124a-124c may be associated with an issuing bank (e.g., the issuer server 134). In one example, the plurality of cardholders 124a-124c may have utilized the payment instruments to perform the payment transactions at the plurality of merchants 126a-126c (e.g., payment terminals associated with the merchants 126a-126c, a merchant website, etc.).

In one embodiment, the plurality of cardholders 124a-124c may have performed the payment transaction online (i.e., by accessing the merchant's website on a web browser or application installed in a computer system) or offline (i.e., by performing the payment transaction on a payment terminal (e.g., point-of-sale (POS) device, automated teller machine (ATM), etc.) installed in a facility). In a successful payment transaction, the payment amount may get debited from the payment account of the plurality of cardholders 124a-124c and get credited to the payment account of the plurality of merchants 126a-126c. In one embodiment, the payment account of the merchants 126a-126c may be associated with an acquirer bank (e.g., the acquirer server 136).

In one embodiment, the issuer server 134 is associated with a financial institution normally called an “issuer bank” or “issuing bank” or simply “issuer”, in which a cardholder may have a payment account, (which also issues a payment card, such as a credit card or a debit card), and provides microfinance banking services (e.g., payment transaction using credit/debit cards) for processing electronic payment transactions, to the cardholder.

In one embodiment, the acquirer server 136 is associated with a financial institution (e.g., a bank) that processes financial transactions. This can be an institution that facilitates the processing of payment transactions for physical stores, merchants, or an institution that owns platforms that make online purchases or purchases made via software applications possible (e.g., shopping cart platform providers and in-app payment processing providers). The terms “acquirer”, “acquiring bank”, “acquiring bank” or “acquirer server” will be used interchangeably herein.

The server system 122 is configured to perform one or more of the operations described herein. In an embodiment, the server system 122 is identical to the server system 102 of FIG. 1A. In another embodiment, the server system 122 is the payment server 140. The server system 122 is a separate part of the environment 120 and may operate apart from (but still in communication with, for example, via the network 132), any third-party external servers (to access data to perform the various operations described herein). However, in other embodiments, the server system 122 may actually be incorporated, in whole or in part, into one or more parts of the environment 120, for example, the cardholder 124a. In addition, the server system 122 should be understood to be embodied in at least one computing device in communication with the network 132, which may be specifically configured, via executable instructions, to perform as described herein, and/or embodied in at least one non-transitory computer-readable media.

The server system 122 is configured to access historical transaction data associated with the plurality of cardholders 124a-124c. The graph database 130 may include the historical transaction data including a plurality of payment transactions performed between the plurality of cardholders 124a-124c and the plurality of merchants 126a-126c. In one embodiment, the payment transactions may be performed between the plurality of cardholders 124a-124c and the plurality of merchants 126a-126c over a time period (e.g., 1 year, 2 years, 7 years, etc.). In one embodiment, the historical transaction data associated with the cardholders 124a-124c may contain a series of asynchronous events or transactions in continuous time. The historical transaction data may further include interactions between multiple entities (such as acquirer, cardholder, merchant, issuer, or the like).

The server system 122 is configured to generate a temporal graph of the plurality of cardholders. In general, the temporal graph is a mathematical abstraction to model diverse relationships between multiple nodes and how their interactions evolve. The server system is configured to implement temporal graph representation learning methods to learn effective node embeddings. These representations should be over continuous time, inductive for nodes unseen in the training, and capable of understanding how edges contribute to neighborhood formation. Temporal edges incident on the nodes in the graph can be viewed as discrete events localized in continuous time. In one embodiment, the server system 122 is configured to utilize a generative probabilistic mathematical framework to model continuous-time event sequences (i.e., temporal point processes (TPP)).

The server system 122 is configured to implement a method to learn the structural and relational properties of the graph using graph neural network (GNN) and temporal event dynamics using TPP at node-level, called the NodeTPP model (see, 128). In the NodeTPP model, the server system 122 is configured to learn neighborhood aggregation using a more flexible neural TPP model based on a sophisticated intensity function. Neural TPPs are capable of modeling non-linear dynamics between entities. The model is optimized based on the likelihood of the sequence, instead of approximating just the next edge probability through the softmax function, as done in the prior works. Edge context is the key to edge and node dynamics. The NodeTPP model learns node dynamics by conditioning nodes on past edge sequence forming edge-contextualized node embeddings. The present disclosure shows significant improvements in the four real-world datasets in predictive performance over previous temporal GNNs and Hawkes process-based GNNs.

The server system 122 is configured to predict likelihoods of future interaction occurrences among the plurality of cardholders or merchants based, at least in part, on a pre-trained NodeTPP model 128.

The likelihoods of future interaction occurrences may further be used to perform one or more downstream applications, such as predicting event occurrences of merchant-cardholder interactions, transaction anomaly detection, anti-money laundering, predicting the next transaction of cardholders, and dynamic edge prediction between cardholder and merchant.

In one embodiment, the payment network 138 may be used by the payment card issuing authorities as a payment interchange network. The payment network 138 may include a plurality of payment servers such as the payment server 140. Examples of payment interchange networks include, but are not limited to, Mastercard® payment system interchange network. The Mastercard® payment system interchange network is a proprietary communications standard promulgated by Mastercard International Incorporated® for the exchange of financial transactions among a plurality of financial activities that are members of Mastercard International Incorporated®. (Mastercard is a registered trademark of Mastercard International Incorporated located in Purchase, N.Y.).

The number and arrangement of systems, devices, and/or networks shown in FIG. 1B is provided as an example. There may be additional systems, devices, and/or networks; fewer systems, devices, and/or networks; different systems, devices, and/or networks; and/or differently arranged systems, devices, and/or networks than those shown in FIG. 1B. Furthermore, two or more systems or devices shown in FIG. 1B may be implemented within a single system or device, or a single system or device shown in FIG. 1B may be implemented as multiple, distributed systems or devices. Additionally, or alternatively, a set of systems (e.g., one or more systems) or a set of devices (e.g., one or more devices) of the environment 120 may perform one or more functions described as being performed by another set of systems or another set of devices of the environment 120.

Referring now to FIG. 2, a simplified block diagram of a server system 200 is shown, in accordance with an embodiment of the present disclosure. The server system 200 is similar to the server system 102 or the server system 122. In some embodiments, the server system 200 is embodied as a cloud-based and/or SaaS-based (software as a service) architecture. The server system 200 includes a computer system 202 and a database 204. The computer system 202 includes at least one processor 206 for executing instructions, a memory 208, a communication interface 210, and a storage interface 214 that communicate with each other via a bus 212.

In some embodiments, the database 204 is integrated into the computer system 202. For example, the computer system 202 may include one or more hard disk drives as the database 204. The storage interface 214 is any component capable of providing the processor 206 with access to the database 204. The storage interface 214 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 206 with access to the database 204. In one embodiment, the database 204 is configured to store a NodeTPP model 228.

Examples of the processor 206 include, but are not limited to, an application-specific integrated circuit (ASIC) processor, a reduced instruction set computing (RISC) processor, a complex instruction set computing (CISC) processor, graphical processing unit (GPU), a field-programmable gate array (FPGA), and the like. The memory 208 includes suitable logic, circuitry, and/or interfaces to store a set of computer-readable instructions for performing operations. Examples of the memory 208 include a random-access memory (RAM), a read-only memory (ROM), a removable storage drive, a hard disk drive (HDD), and the like. It will be apparent to a person skilled in the art that the scope of the disclosure is not limited to realizing the memory 208 in the server system 200, as described herein. In another embodiment, the memory 208 may be realized in the form of a database server or cloud storage working in conjunction with the server system 200, without departing from the scope of the present disclosure.

The processor 206 is operatively coupled to the communication interface 210 such that the processor 206 is capable of communicating with a remote device 216 such as, the payment server 140, or communicating with any entity connected to the network 110 (as shown in FIG. 1A) or the network 132 (as shown in FIG. 1B). In one embodiment, the processor 206 is configured to access historical transaction data including a plurality of payment transactions performed between the plurality of cardholders 124a-124c and the plurality of merchants 126a-126c from the graph database 130.

It is noted that the server system 200 as illustrated and hereinafter described is merely illustrative of an apparatus that could benefit from embodiments of the present disclosure and, therefore, should not be taken to limit the scope of the present disclosure. It is noted that the server system 200 may include fewer or more components than those depicted in FIG. 2.

In one embodiment, the processor 206 includes a data pre-processing engine 218, a graph creation engine 220, a node feature extractor 222, a neighborhood aggregation engine 224, and an optimization engine 226. It should be noted that components, described herein, such as the data pre-processing engine 218, the graph creation engine 220, the sampling engine 222, the neighborhood aggregation engine 224, and the optimization engine 226 can be configured in a variety of ways, including electronic circuitries, digital arithmetic and logic blocks, and memory systems in combination with software, firmware, and embedded technologies.

The data pre-processing engine 218 includes suitable logic and/or interfaces for accessing historical interaction data including a plurality of interactions associated with the plurality of entities from a database (e.g., the graph database 106) for a time period (e.g., 1 month, 6 months, 1 year, 2 years, etc.).

With reference to the FIG. 1B, the data pre-processing engine 218 is configured to extract historical transaction data from a transaction database. The historical transaction data, but is not limited to, includes payment transactions performed between the plurality of cardholders 124a-124c and the plurality of merchants 126a-126c within a particular time interval. In one example, the historical transaction data includes information such as merchant name identifier, unique merchant identifier, a timestamp, geo-location data, information of the payment instrument involved in the payment transaction, and the like. The historical transaction data defines relationships between cardholder accounts and merchants. For example, when a cardholder purchases an item from merchant A at time t1, a relationship is defined. Thus, the historical transaction data can be leveraged to expose a variety of different attributes of the accounts, such as account activity, customer preferences, similarity to other accounts, and the like. However, the historical transaction data is sparse, as any given cardholder account (which includes merchant accounts that perform transactions with other merchants) interacts with a small fraction of merchants. Similarly, any given merchant may interact with a fraction of the cardholder accounts.

In one embodiment, the data-preprocessing engine 218 is configured to perform operations (such as data-cleaning, normalization, feature extraction, and the like) on the historical transaction data. In one embodiment, the data pre-processing engine 218 may use natural language processing (NLP) algorithms to extract a plurality of node features based on the historical interaction data or the historical transaction data. In one embodiment, the plurality of node features associated with entities is converted into intermediate vector representations to be fed as an input to the TPP-based GNN model 228. In one embodiment, the plurality of node features may include, but is not limited to, geo-location data associated with the payment transactions, population density, transaction velocity (i.e., frequency of financial transaction among the cardholders 124aa-124c), historical fraud data, and transaction history. In one embodiment, the plurality of graph features is converted into a plurality of feature vectors.

The graph creation engine 220 includes suitable logic and/or interfaces for generating a temporal graph based, at least in part, on the historical transaction or interaction data. The temporal graph dataset consists of a chronological sequence of edges. Each temporal edge defines an interaction between two nodes or entities. The temporal graph represents a computer-based graph representation of the plurality of entities 104a-104c as nodes. In addition, interactions/relationships among the nodes are represented as temporal edges (i.e., weighted, or unweight). For any particular node, the processor 206 is configured to create an event sequence of incident edges in the past. These past interactions of the node are asynchronous temporal events localized in continuous time. The main objective of the node level TPP based GNN model 228 (i.e., NodeTPP model) is to implement continuous-time modeling to capture topological evolution, inductiveness, and node embeddings conditioned on past edges.

In one embodiment, the processor 206 is configured to execute a plurality of operations to determine a node representation of each node in the temporal graph based, at least in part, on the NodeTPP model 228. In one embodiment, the NodeTPP model 228 may execute or run machine learning algorithms based on TPP based graph neural networks (GNNs). The NodeTPP model 228 focuses on edge event sequence formation while learning interactions of the past edges on the current nodes. This node-level perspective models the asynchronous incident edge sequence as a TPP.

The node feature extractor 222 includes suitable logic and/or interfaces for generating a plurality of edge embeddings associated with a first or source node based, at least in part, on node features or intermediate vector representations of the first node and a plurality of direct neighbor nodes of the first node. The node feature extractor 222 is a fully connected layer (FCL). First, an incident edge sequence on the source node is defined. The incident edge sequence is a time-ordered sequence of the plurality of edges of the source node. The initial node features corresponding to the source node are standardized by subtracting the mean and scaling to unit variance. Based on the initial node features, the node feature extractor 222 is configured to generate first-node features. In a similar manner, neighbor node features of the direct neighbor nodes of the first node are generated. Thereafter, the node feature extractor 222 is configured to concatenate the first node vectors and the neighbor node features with a time of interaction (i.e., inter-edge time) to obtain an edge embedding sequence. Thus, a plurality of edge embeddings is generated according to the time of interaction of the first node and direct neighboring nodes of the temporal graph.

In some embodiments, an embedding can be a mapping of a discrete or categorical variable to a vector of continuous numbers. In the context of neural networks, embeddings can be low-dimensional, learned continuous vector representations of discrete variables. Neural embeddings can be useful because they can reduce the dimensionality of categorical variables and meaningfully represent categories in the transformed space. In some embodiments, a vector that may represent the node can be determined using a neural network.

The neighborhood aggregation engine 224 includes suitable logic and/or interfaces for generating edge-contextualized node embeddings of the first node corresponding to the plurality of edge embeddings based, at least in part, on a recurrent neural network (RNN) model. More particularly, the current node embedding is obtained by aggregating its own node features and past neighbor's features using the RNN model in GNN layers. In other words, the processor 206 is configured to generate node embeddings of each node that are contextualized on incident edge sequence for capturing influences of neighboring nodes and understanding time-level event characteristics.

In one embodiment, the NodeTPP model 228 utilizes a recurrent neural network (RNN) as backbone architecture to learn the first embedding (i.e., the temporal embedding) based on analysis of past events. In general, RNN is a feed-forward neural network structure. In RNN, additional edges (also known as recurrent edges) are added such that the outputs from the hidden units at the current time step are fed into them again as future inputs at the next time step. In consequence, the same feed-forward neural network structure is replicated at each time step, and the recurrent edges connect the hidden units of the network replicated at adjacent time steps across time. In RNN, the hidden units with recurrent edges not only receive the input from the current data sample but also from the hidden units in the last time step. This feedback mechanism creates an internal state of the network to memorize the influence of each past data sample. The NodeTPP model 228 fetches the incident edge sequence of a source node and generates the edge-contextualized node embedding of the source node.

The optimization engine 226 is configured to compute likelihoods of future interaction occurrences associated with the first node with a target node based, at least in part, on the edge-contextualized node embeddings and a conditional intensity function. In particular, the optimization engine 226 is configured to calculate conditional intensities for each past edge and estimate likelihoods of future interaction occurrences based, at least in part, on computations of conditional intensities for the incident edge sequence of the source node. As edge-contextualized node embeddings are conditioned on past events while computing intensity, the likelihood functions (i.e., conditional probability density function (PDF) of the edge between source node and target nodes) are also conditioned on past events.

In one embodiment, the NodeTPP model 228 is trained based, at least in part, on a dual loss function that is calculated based on a weighted sum of a first loss value and a second loss value. The training objective of the NodeTPP model 228 is negative log-likelihood of temporal sequence incident on a particular node. As the NodeTPP model 228 is based on the GNN model, it can infer unseen training nodes owing to its inductive nature.

In one embodiment, the first loss value is a negative log-likelihood of the likelihood function on the incident edge sequence for each node. The second loss value preserves the temporal dynamics of nodes using smooth L1 and L2 loss. The smooth L1 loss is less sensitive to the outliers compared to the mean squared error. The nodes in the temporal dataset could have a varied range of links forming at particular times. The smooth L1 loss provides steady gradients on a large number of events using L1 loss and reduces oscillation while updating the few numbers of events using L2 loss.

In one embodiment, the optimization engine 226 is configured to perform the optimization process to indirectly use the plurality of node feature vectors (i.e., self-node features of the node) to learn the hidden representations. The optimization process is also performed to make the hidden representations useful to perform the one or more downstream applications and/or tasks.

In one embodiment, the processor 206 is configured to at least one of a plurality of graph context prediction tasks based, at least in part, on the likelihoods of future interaction occurrences among the set of entities. The plurality of graph context prediction tasks may include, but not limited to, (a) predicting event occurrences of merchant-cardholder interactions, (b) transaction anomaly detection, (c) anti-money laundering, (d) predicting next transaction of cardholders, (e) dynamic edge prediction between cardholder and merchant.

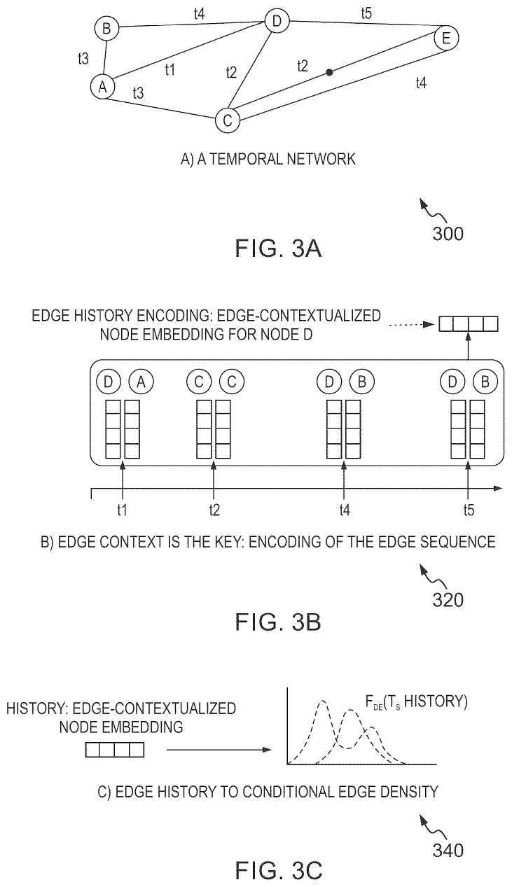

FIGS. 3A-3C depict example representations of predicting future interactions between a source node and a target node in a given temporal network, in accordance with an embodiment of the present disclosure.

As explained above, the processor 206 is configured to generate a temporal graph based on historical interaction data of the plurality of entities. The relationship between the nodes is set forth in solid, dashed, and/or bolded lines (e.g., with arrows).

Referring now to FIG. 3A, an example representation 300 of a temporal graph G is shown. The temporal graph G is a time-ordered event sequence.

The temporal graph G represents a computer-based graph representation of the plurality of entities as the nodes A-E and their interactions as edges. In one embodiment, the edges may represent payment transactions performed between the plurality of entities A-E. The temporal graph G represents the following interactions occurring at different time points among the plurality of entities A-E. The temporal graph G considers node D as a source node and node E as a target node.
(a) At time t1, entity D has interacted with entity A. (b) At time t2, entity D has interacted with entity C. (c) At time t4, entity D has interacted with entity B.

In this representation, each interaction between two entities is considered as an edge in the temporal graph. The edges are labeled with the type of interaction, and the timestamps (t1, t2, t3, t4) indicate when these interactions occurred.

FIG. 3B is an example representation 320 of generating an edge contextualized node embedding of the source node D, in accordance with an embodiment of the present disclosure. Based on the temporal graph G, the processor 206 is configured to generate an incident edge sequence for the source node D. The “incident edge sequence” refers to a sequence of edges incident to a specific node over a period of time. In other words, it represents the set of edges that involve a particular node as one of their endpoints, ordered based on their timestamps. The concept of incident edge sequences is useful in analyzing the temporal behavior of individual nodes in the graph. It allows us to study how the interactions involving a specific node change over time, revealing patterns, trends, and relationships. With reference to FIG. 3B, the incident edge sequence on the source node D is (D, A, t1), (D, C, t2), (D, B, t4), and (D, E, t5). Thereafter, the processor 206 is configured to generate an edge-contextualized node embedding for the source node D based on edge history encoding for the source node D. The edge history encoding is generated by considering the incident edge sequence as temporal contexts. In one embodiment, the processor 206 is configured to model the incident edge sequence as a temporal point process (TPP), where edge history is encoded to get the edge-contextualized node embedding for the source node D.

In general, the TPP model is a generic framework for asynchronous time-series data that allows the modeling of inter-event time as a continuous random variable. A temporal point process (TPP) is a random process whose realizations consist of a sequence of strictly increasing arrival times T={t1, . . . , tN}. The TPP can be represented as a sequence of strictly positive inter-event times πi=ti−ti−1. The traditional way of specifying the dependency of the next arrival time t on the history Ht={tj∈T: tj<t} is using the conditional intensity function λ*(t):=λ(t|Ht).

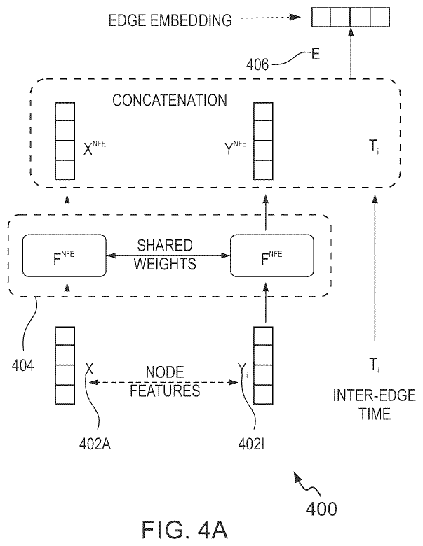

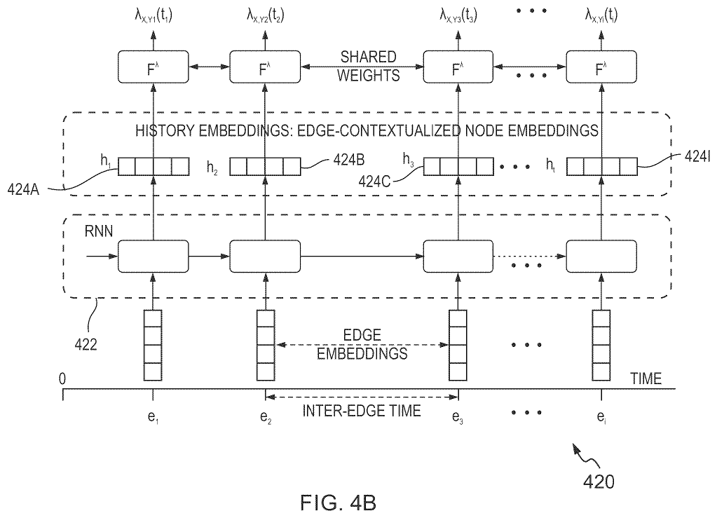

FIG. 3C is an example representation 340 of determining inter-edge time density f_{D,E}(t₅|history) (i.e., conditional intensity function). A detailed explanation for determining inter-edge time density is herein explained in detail with reference to FIG. 4B, and therefore, it is not reiterated for the sake of brevity.

FIG. 4A and 4B are block diagram representations 400 and 420 of the NodeTPP model 228, in accordance with an embodiment of the present disclosure. The block diagram representations 400 and 420 explain the end-to-end training process of NodeTPP model, starting from neighborhood aggregation strategy, method of learning from edge-contextualized node embedding, and a novel dual loss function to optimize the temporal graph in a self-supervised approach. For illustration purposes, it is assumed that the NodeTPP model 228 learns node representation of source node ‘x’. In a similar manner, the processor 206 is configured to perform the training process for all remaining nodes in a graph traversal manner. While learning interactions of the past edges on the current nodes, the processor 206 is configured to form edge event sequences for the source node. This node-level perspective helps in modeling the asynchronous incident edge sequence as a TPP. Specifically, to comprehend the dynamics of the current edge involving the source node and target node, the processor 206 is configured to condition their current embeddings on incident edge sequences called edge-contextualized node embeddings. Thus, the processor 206 is configured to implement a flexible neural-network-based TPP model with complex conditional intensity functions to learn these embeddings. Further, the processor 206 is configured to utilize RNNs to model sequence dynamics.

At first, the processor 206 is configured to generate a temporal graph. A temporal graph is a time-ordered event sequence. Let V and E be the vertex set and edge set respectively. Then, a temporal graph is defined as G=(e₁, e₂, . . . , e_{|E|}). Each event eᵢ=(source, target, t)ᵢ defines an edge between nodes (source, target)∈V, occurring at time tᵢ. For a given source node x, the incident edge sequence with N edges is represented as Eₓ={e₁: (y₁, t₁), e₂: (y₂, t₂), . . . , e_{N}=(y_{N}, t_{N})} where eᵢ∈E is an edge between source x and target yᵢ, both ∈V at time tᵢ. Also, t₁<. . . <t_{N} are edge arrival times defining neighborhood formation around source x. Thus, the temporal graph G defines all edges in the graph while Eₓ defines edges only incident on source node x. The node features or intermediate vector representation associated with the nodes {x, y₁, y 2, . . . , y_{N}} are represented in bold as {x, y₁, y₂, . . . , y_{N}}∈R d respectively where d is the feature dimension.

For each edge eᵢ=(yᵢ, tᵢ) in incident edge sequence Ex, the initial node features x (see, 402a) of the source node and neighbor nodes y₁, y₂, . . . , y_{N} (see, 402i) are passed through a node feature extractor (see, 404) to get x^{NFE}∈R^{d}^{_{NFE}} as x^{NFE}=f^{NFE}(x, θ_{NFE}). The initial node features x (see, 402a) for node x are standardized by subtracting the mean and scaling to unit variance. The node feature extractor 404 is a fully connected layer (FCL) with parameters θ_{NFE} is used to implement f^{NFE}. The node feature extractor 404 captures the generic properties of nodes. The same procedure is repeated to get yᵢ^{NFE} from yᵢ (see, 402b). Then, the processor 206 is configured to concatenate x^{NFE} and yᵢ^{NFE} with the time of interaction, i.e., inter-edge time τᵢ=tᵢ−tᵢ₋₁ to obtain edge embedding as:

$${e}_{i} = CONCAT ( {x}^{NFE} , {y}_{i}^{NFE} , {τ}_{i} ) \qquad Eqn . ( 1 )$$

The resulting edge embedding eᵢ (see, 406) is obtained by concatenating the extracted features x^{NFE}, yᵢ^{NFE}, and the inter-edge time τᵢ.

Thereafter, the processor 206 is configured to process a plurality of edge embeddings e₁, e₂, . . . e_{N} using recurrent neural network (RNN) 422 to obtain the edge-contextualized node embeddings hᵢ (see, 424a, 424b, 424c . . . , 424n). The output embeddings of the RNN 422 for each step capture the relationship between the source node and target node along with edge time information. The output embeddings are called edge-contextualized node embeddings, denoted by hᵢ∈R^{d}^{_{ctx}}, at different edges for a given source node x. Here, d_{ctx} denotes context length. With the initial hidden state of h₀, the next hidden state of the RNN 422 is updated as hᵢ=UPDATE(hᵢ₋₁,eᵢ). These node embeddings hᵢ are then fed to the f^{λ} to get conditional intensities \hat{λ}_{x,y}_{ᵢ}(tᵢ) for each edge-time t i as follows:

$${\hat{λ}}_{x . {y}_{i}} ( {t}_{i} ) = {f}^{λ} ( {h}_{i} ; {θ}_{λ} ) \qquad Eqn . ( 2 )$$

These embeddings are used to compute conditional intensities λ_{x, y i}(tᵢ) via function f_{λ}. In other words, the current node embedding is obtained by aggregating its own features and past neighbor's features using RNN in GNN layers.

Conditional Intensity Estimation: In one embodiment, the processor 206 is configured to calculate the intensity of each edge in the event sequence. A conditional intensity is computed for each past edge which is further used to calculate edge density.

Consequently, the overall algorithm of calculating the conditional intensity of each edge in an even sequence can be defined as follows:

Algorithm 1: Conditional Intensity Estimation Algorithm:

```
Function compute_intesity (Eₓ):
  l_{λ} ← [ ]
  for eᵢ ∈ Eₓ do
      // extract source and target node features x and y i
        x^{NFE} ← node_feature_extractor(x);
        yᵢ^{NFE} ← node_feature_extractor(x);
        // calculate inter-edge arrival time
        τᵢ = tᵢ − tᵢ₋₁;
          // concatenate x^{NFE}, yᵢ^{NFE}, and τᵢ to get edge embedding eᵢ
        eᵢ = CONCAT(x^{NFE}, yᵢ^{NFE}, τᵢ)
          // RNN step
        hᵢ = UPDATE(hᵢ₋₁, eᵢ) ;
        // calculate intensity for a given edge
      λ_{x,y}_{ᵢ}(tᵢ) → softplus(intesity_layer(hᵢ));
      // append edge intensity to l_{λ}
        l_{λ}.append (λ_{x,y}_{ᵢ} (tᵢ));
    end for
return l_{λ}
```

TPP Based GNN: As previously disclosed, the processor 206 is configured to determine temporal node embeddings h^{t}ₓ and h^{t}_{y} to calculate conditional intensity λ_{x,y}(t)=f(h^{t}ₓ, h^{t}_{y}). In general, GNNs are well known for efficient node embeddings along with their inductive nature. The message-passing scheme in GNNs aggregates information from the neighborhood and shares updated information. In existing methods, Hawkes process-based GNNs compute node embeddings by combining self-information and neighbor information based on weight decay kernel κ. Let hₓ^{t,l}∈R^{d}ₗ is dₗ dimensional embedding for node x at time t from GNN layer l. TREND uses the following formulation to obtain node embeddings using GNN:

$${h}_{x}^{t , l} = σ ( {h}_{x}^{t , l - 1} {W}_{self}^{l} + {\sum }_{( x , {y}^{′} , {t}^{′}} ) \qquad Eqn . ( 3 )$$

$${h}_{{y}^{′}}^{{t}^{′} , l - 1} {W}_{hist}^{l} {κ}_{x} ( t - {t}^{′} ) )$$

where, σ is activation function, W self∈R^{d}^{_{l−1}}^{×d}^{ₗ} and Wₕᵢₛₜ∈R^{d}^{_{l−1}}^{×d}are learnable weight matrices on self-information and neighbor information. Due to the Hawkes-process-based model's limitations, especially model misspecification, these node embeddings are not rich enough in information. Thus, TREND uses multiple modules like hypernetworks and FiLM on top of Hawkes-process-based GNN outputs to refine node embeddings.

In the proposed NodeTPP model 228, the processor 206 is configured to learn efficient and information-rich node embeddings through flexible TPP-based GNNs. This objective is achieved by using RNN, in place of summation in Eqn. (1), which learns complex non-linear temporal event interactions including chronological order, number, and timing of the past events. The model misspecification problems in Hawkes-process-based models like inherent inertia and inhibition effect between the events are addressed through RNNs as they implicitly model these event dynamics. Due to this, the excitation and inhibition effects of the past events stochastically influence the intensities of the future events. The neighbor-hood aggregation (self-information and neighbor information) in the GNN layer using RNN allows us to obtain node embeddings with better quality. Given incident edge sequence on node x as Ex={e₁: (y₁, t₁), e₂: (y₂, t₂), . . . , e_{N}=(y_{N}, t_{N})}, the processor 206 is configured to learn di dimensional edge-contextualized node embedding through GNN layers. Mathematically, the edge-contextualized node embedding hₓ^{t,l}∈R_{ctx}^{d}^{^{l}} using GNN layers as follows:

$${h}_{x}^{t , l} = {f}^{l} ( {h}_{x}^{t , l - 1} , {h}_{y 1}^{t , l - 1} , {h}_{y 2}^{t , l - 1} , … , {h}_{y N}^{t , l - 1} ) \qquad Eqn . ( 4 )$$

where, for each GNN layer l, f^{l} is realized using RNN. Specifically, for the given Eₓ, the output of each RNN step is edge-contextualized (conditioned on prior edges) for the source node x, hence it is called edge-contextualized node embedding. For a one layer (l=1) GNN¹, h₁,h₂,, . . . ,hᵢ, indicate these embeddings for the incident edge sequence e₁, e₂, . . . eᵢ as shown in the FIG. 4B.

Thereafter, the processor 206 is configured to implement fully-connected layers 426 (FCL) having θ_{λ} as learnable parameters. Steps involved in the intensity computation are shown in FIG. 4B. As the excitation and inhibition effects of the past events stochastically influence the intensities of the future events, intensity value can both increase or decrease. However, the overall intensity could not be negative. To ensure this, the following softplus function is used as a non-linear transfer function fₜ: R→R₊ to ensure intensity λ_{x,y}_{ᵢ}(tᵢ) is always positive.

$${λ}_{x , {y}_{i}} ( {t}_{i} ) = {f}_{t} ( \hat{λ} ) = log ( 1 + exp ( \hat{λ} ) ) ; \qquad Eqn . ( 6 )$$

To calculate conditional intensity for each edge λ_{x,y}_{ᵢ}(tᵢ), the prior methods first calculate embeddings of source node x and target node tᵢ, independently. Next, these methods compute the intensity using FCL where input is squared Euclidean distance λ_{x,y}_{ᵢ}(tᵢ)=f(hₓ^{t}, h_{y}^{t})=f(∥hₓ^{t}−h_{y}^{t}∥². On the contrary, the proposed NodeTPP model 228 learns edge contextualized node embeddings hₓ^{t}^{ᵢ}=hᵢ directly as an output of the RNN 424, thereby allowing flexible modeling of edge dynamics. Thus, the hₓ^{t}^{ᵢ} already contains information about the target node yᵢ as edge eᵢ=(yᵢ, tᵢ)∈Eₓ has source node x, target node yᵢ at times tᵢ.

Likelihood Estimation: In one embodiment, the processor 206 is configured to compute conditional probability density function (PDF) of the edge between source node x and target node y at time tᵢ is given as:

$${f}_{x , {y}_{i}} ( {t}_{i} ) = {λ}_{x , {y}_{i}} ( {t}_{i} ) exp ( - {\int }_{τ = {t}_{i - 1}}^{{t}_{i}} {λ}_{x , {y}_{i}} ( τ ) d τ ) \qquad Eqn . ( 7 )$$

where, f_{x,y}_{ᵢ}(tᵢ) is PDF over inter-edge time tᵢ−tᵢ₋₁. The conditional intensity λ_{x,y}_{ᵢ}(tᵢ) for each edge in Eₓ is calculated using Equation 6. Later, PDF f_{x,y}_{ᵢ}(tᵢ) for each inter-edge time is obtained using Equation 7. In the NodeTPP model 228, the maximum likelihood estimation (MLE) is utilized to estimate TPP parameters. The likelihood is a joint density function of all edges observed in the Ex: tᵢ∈[0,T). One can factorize it with the product of individual edge densities conditioned on all previous edges.

As edge-contextualized node embeddings are conditioned on past events while computing intensity (Equation 5), the PDFs are also conditioned on past events. Therefore, the likelihood function is defined as

$$L = {f}_{x , {y}_{1}} ( {t}_{1} ) {f}_{x , {y}_{2}} ( {t}_{2} ) … {f}_{x , {y}_{N}} ( {t}_{N} ) ( 1 - {f}_{x , {y}_{N}} ( T ) ) \qquad Eqn . ( 8 )$$

where, last term (1−f_{x,y}_{_{N}}(T)) indicates no event has occurred between the time interval (t_{N},T).

The negative log-likelihood (NLL) version of L using conditional intensity function is given as:

$${L}_{x}^{NLL} = - {\sum }_{i = 1}^{i = N} \qquad Eqn . ( 9 )$$

$$log ( {λ}_{x , {y}_{i}} ( {t}_{i} ) ) + {\int }_{τ = 0}^{T}$$

$$Λ ( τ ) d τ$$

where, Λ(τ)=Σⱼ₌₁^{|V|}λ_{x,y}_{ⱼ}(τᵢ). The first term (denoted as L^{obs}) in the above equation indicates the NLL over observed events and conditional intensities within the first term is calculated using the conditional intensity estimation algorithm. The second term (denoted as Lₓ^{surv}) is an addition of infinitely many event log probabilities that are not occurring at node x called survival probability. The integration in Equation 8 is approximated using the Monte Carlo trick and in below Algorithm 2. The negative nodes in the algorithm 2 are obtained through the commonly used neighborhood sampling approach.

Algorithm 2: Integral Estimation In Equation 9

```
Function compute_survial (Eₓ , l_{neg} , K, Q ):
  Lₓ^{surv} ← 0
  for i ← 0 to K − 1 do
      // get current negative node from list l neg
          n_{neg} = l_{neg}[i];
          for j ← 1 to Q do
          //take time sample
        // uniformly sample from edge index
            idx ~ Unif(1, 2, ..., N) ;
        // replace the node in edge e idx with negative node
            e_{idx} = (y_{idx} = n_{neg}, t_{idx});
        // remove edges with time tᵢ > t_{idx}
          Eₓ = {e₁,...,e_{idx} = (y_{idx} = n_{neg}, t_{idx})};
        // Intensity calculation on updated Eₓ using Algorithm 1
          Lₓ^{surv} += log (λ_{x,n}_{_{neg}}(t));
    end for
end for
// normalize survival probability
Lₓ^{surv} = Lₓ^{surv} /(K × Q);
return Lₓ^{surv};
```

Modeling Temporal Characteristics of Nodes: As described earlier, the processor 206 is configured to calculate λ_{x,y}_{ᵢ}(tᵢ) and then log-likelihood Lₓ^{NLL} on the incident edge sequence. The important characteristic of the nodes over the sequences is variation in the degree at different edge times. A node forms a different number of edges at different times. Any two highly interactive nodes in the temporal network are likely to interact with each other. It is the likelihood of nodes to form new links at a given time. Let us denote the number of new edges incident on source node at time t by ΔNₓ(t). Then, the estimator of the node dynamics is defined as ΔNₓ(t)=f_{node}(hₓ^{t}; θ_{node}), where f_{node} is a FCL with learnable parameters θ_{node} to fit a number of new edges on the source node x at time t. Further, the processor 206 is configured to utilize smooth L1 loss to learn node dynamics. It is a combination of L1 loss and L2 loss. The smooth L1 loss is less sensitive to the outliers compared to the mean squared error. The nodes in the temporal dataset could have a varied range of links forming at particular times. The smooth L1 loss provides steady gradients on a large number of events ΔNₓ(t) using L1 loss and reduces oscillation while updating the few numbers of events ΔNₓ(t) using L2 loss. It is defined as follows: L_{x,t}^{node}={0.5(ΔNₓ(t)−ΔN\hat{ }ₓ(t))², if |ΔNₓ(t)−ΔN\hat{ }ₓ(t)|<1|ΔNₓ(t)−ΔN\hat{ }ₓ(t)|−0.5, otherwise}. . . Eqn. (10)

NodeTPP Algorithm: The learning procedure in the NodeTPP model 228 involves the computation of NLL Lₓ^{NLL} over incident edge sequence Eₓ on the source node x along with modeling node dynamics L_{x,t}^{node}. The overall training objective for NodeTPP is as follows:

$${L}_{x} = {L}_{x}^{NLL} + {λ}_{n o d e} {L}_{x , t}^{node} \qquad Eqn . ( 11 )$$

where, λ node is a hyperparameter to control the contribution of node to the final loss. Steps involved in the NodeTPP dynamics loss L_{x,t}^{node} are described in Algorithm 3.

Algorithm 3: NodeTPP

```
Input: Current event with source node x, target node y and edge
time t, list of K negative nodes as l_{neg} , number of time samples Q
Output: NodeTPP loss Lₓ
Fetch N − 1 historical neighbors of x from current edge as:
  Eₓ = {e₁: (y₁, t₁), e₂: (y₂, t₂),..., e_{N}: (y_{N} = y, t_{N} = t)}
Get features for source node and all neighbors x, yᵢ
//calculate edge intensities:
      l_{λ} ← compute_intesity(Eₓ);
// calculate Lₓ^{obs}
Lₓ^{obs} = − Σᵢ₌₁^{i=N} log(l_{λ}[i]) ;
// calculate Lₓ^{surv}
    Lₓ^{surv} ← compute_survival(Eₓ, l_{neg}, K, Q) ;
// compute node dynamics L_{x,t}^{node}
L_{x,t}^{node} ← compute_node_dyn(x,t);
Lₓ^{NLL} = Lₓ^{obs} + Lₓ^{surv}
// Final NodeTPP loss
Lₓ = Lₓ^{NLL} + λ_{node} L_{x,t}^{node}
return Lₓ
```

In one embodiment, the loss Lₓ is minimized using mini-batch stochastic gradient descent.

Time Complexity Analysis: The time complexity for Algorithm 1 is O (N), where N=|Eₓ| is the length of the incident edge sequence (number of neighbors). Let K and Q denote the number of negative samples and the time samples for each negative sample respectively. Then, the survival computation (Algorithm 2) has a time complexity of O (KQN). The training time complexity of NodeTPP (Algorithm 3) is O (Eₚ|I^{tr}|KQN^{l}), where Eₚ is a number of training epochs and I^{tr} denotes the number of training samples. Here, l indicates the number of GNN layers.

In one embodiment, all the model parameters are learned via stochastic gradient descent with the Adam optimizer. In addition, the training iterations are repeated until convergence. The learned embeddings are concatenated with the node's self-node features and can cater to one or more different domain-agnostic downstream applications and/or tasks.

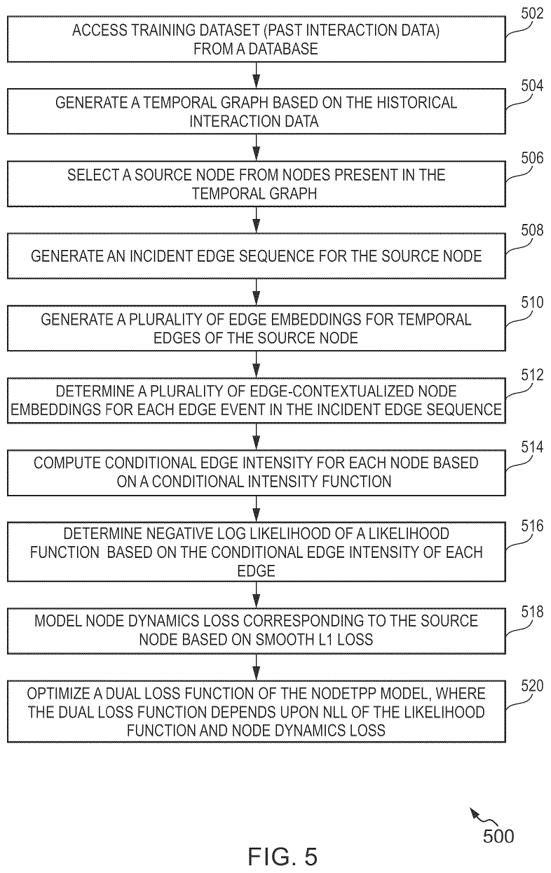

FIG. 5 represents a flow chart 500 of a method for training NodeTPP model, in accordance with an embodiment of the present disclosure. The sequence of operations of the flow chart 500 may not be necessarily executed in the same order as they are presented. Further, one or more operations may be grouped and performed in form of a single step, or one operation may have several sub-steps that may be performed in parallel or in a sequential manner. It is to be noted that to explain the flow chart 500, references may be made to elements described in FIG. 1 and FIG. 2.

At operation 502, the method 500 includes accessing, by the server system 200, training dataset i.e., past interaction data (e.g., past transaction data) including the plurality of interactions (e.g., payment transactions) from the database (e.g., the graph database 106 or the graph database 130).

At operation 504, the method 500 includes generating a temporal graph based on the historical interaction data. The temporal graph represents a computer-based graph representation of the plurality of entities as nodes and time-ordered event sequences between nodes as temporal edges.

At operation 506, the method 500 includes selecting a source node from the nodes. This process is performed iteratively for each node of the temporal graph. The method further includes identifying direct neighbor nodes of the source node.

At operation 508, the method 500 includes generating an incident edge sequence Eₓ for the source node. The incident edge sequence includes a series of events or interactions of the source node with neighbor nodes.

At operation 510, the method 500 includes generating a plurality of edge embeddings for temporal edges of the source node. For each edge eᵢ=(yᵢ, tᵢ) in the incident edge sequence, initial node features are passed through a fully connected layer (i.e., node feature extractor). The resulting edge embedding eᵢ is obtained by concatenating the extracted features x^{NFE}, yᵢ^{NFE}, and the inter-edge time τᵢ.

At operation 512, the method 500 includes determining a plurality of edge-contextualized node embeddings for each edge event in the incident edge sequence. The plurality of edge-contextualized nodes is obtained by aggregating its own features and past neighbor nodes features using RNN in GNN layers.

At operation 514, the method 500 includes computing conditional edge intensity for each node based, at least in part, on a conditional intensity function (see, algorithm 1).

At operation 516, the method 500 includes determining negative log likelihood (NLL) of a likelihood function (see, Eqn. 8) based on the conditional edge intensity of each edge.

At operation 518, the method 500 includes modeling node dynamics loss corresponding to the source node based, at least in part, on smooth L1 loss.

In general, the smooth L1 loss is a loss function commonly used in machine learning and deep learning, especially in scenarios where the data might contain outliers or noise. It is often used in object detection, regression tasks, and other applications where the goal is to minimize the difference between predicted values and ground truth values. The smooth L1 loss combines the properties of both the Mean Absolute Error (L1 loss) and the Mean Squared Error (L2 loss) while attempting to mitigate the sensitivity to outliers that the L2 loss can exhibit.

At operation 520, the method 500 includes optimizing a dual loss function (see, Eqn. 11) of the NodeTPP model 228, where the dual loss function depends upon the first loss value (i.e., the NLL of the likelihood function (see, Eqn. 9)) and second loss value (i.e., node dynamics loss (see, Eqn. 10)). In one embodiment, the method 500 includes minimizing the dual loss function using mini-batch stochastic gradient descent.

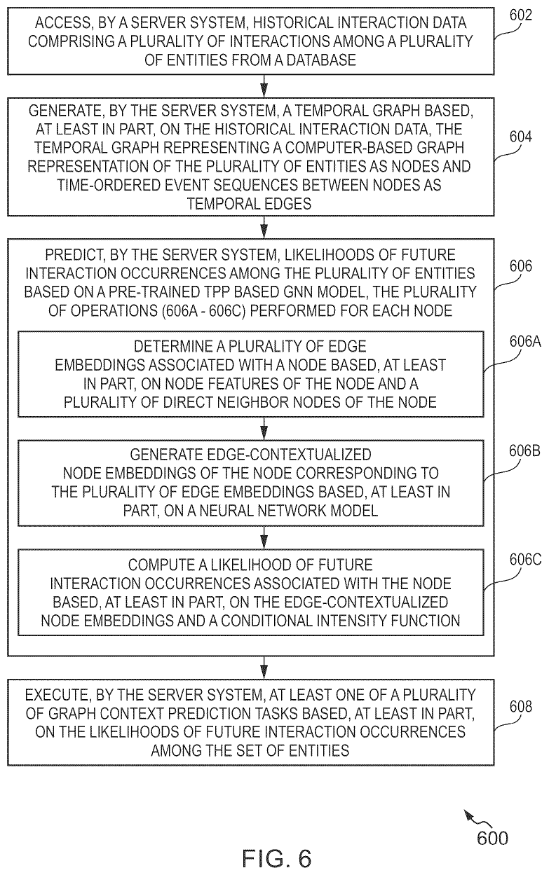

FIG. 6 illustrates a flow diagram depicting a method 600 for temporal graph

representation learning based on node-level temporal point processes and graph neural networks, in accordance with an embodiment of the present disclosure. The method 600 depicted in the flow diagram may be executed by, for example, the server system 200. Operations of the method 600, and combinations of operation in the method 600, may be implemented by, for example, hardware, firmware, a processor, circuitry, and/or a different device associated with the execution of software that includes one or more computer program instructions. The operations of the method 600 are described herein may be performed by an application interface that is hosted and managed with help of the server system 200. The method 600 starts at operation 602.

At operation 602, the method 600 includes accessing, by the server system 200, historical interaction data (e.g., historical transaction data) including the plurality of interactions (e.g., payment transactions) from the database (e.g., the graph database 106 or the graph database 130). Each interaction is associated with at least one entity of the plurality of entities 104a-104c (e.g., the plurality of cardholders 124a-124c).

At operation 604, the method 600 includes generating, by the server system 200, a temporal graph based, at least in part, on the historical interaction data. The temporal graph represents a computer-based graph representation of the plurality of entities as nodes and time-ordered event sequences between nodes as temporal edges.

At operation 606, the method 600 includes predicting, by the server system 200, likelihoods of future interaction occurrences among the plurality of entities based, at least in part, on a pre-trained temporal point process (TPP) based graph neural network (GNN) model (i.e., NodeTPP model 228). The likelihoods of the future interaction occurrences are determined by executing a plurality of operations for each node in a graph traversal manner. The plurality of operations is depicted in operations 606A-606C that are performed for each node, by selecting a node at a time in sequence or in parallel mode.

At operation 606A, the method 600 includes determining, by the server system 200, a plurality of edge embeddings associated with a node based, at least in art, on node features of the node and a plurality of direct neighbor nodes of the node.

At operation 606B, the method 600 includes generating, by the server system, edge-contextualized node embeddings of the node corresponding to the plurality of edge embeddings based, at least in part, on a neural network model.

At operation 606C, the method 600 includes computing, by the server system 200, a likelihood of future interaction occurrences associated with the node based, at least in part, on the edge-contextualized node embeddings and a conditional intensity function.

At operation 608, the method 600 includes executing, by the server system 200, at least one of a plurality of graph context prediction tasks based, at least in part, on the likelihoods of future interaction occurrences among the plurality of entities.

The sequence of operations of the method 600 need not be necessarily executed in the same order as they are presented. Further, one or more operations may be grouped together and performed in the form of a single step, or one operation may have several sub-steps that may be performed in parallel or in a sequential manner.

### Experiments and Results

In the experiments, the performance of the NodeTPP model is compared against state-of-the-art algorithms on different benchmark tasks. This section summarizes the experimental setup, results, and ablation study of the NodeTPP model performance.

### Datasets

Four public datasets are used in the evaluation of embodiments: (a) CollegeMsg, (b) cit-HepTh, (c) Wikipedia, and (d) Taobao. Each dataset is diverse in terms of the number of temporal events, new (inductive) nodes in the testing, and varying average node degrees.

CollegeMsg: This anonymized dataset of communications at UC Irvine only includes anonymized user IDs and time of interaction. A temporal edge (x, y, t) means user x messaged user y at time t. One-hot encoding was used due to the absence of node features.

cit-HepTh: It contains citations between papers in the high energy physics phenomenology section of the arXiv, from January 1993 to April 2003. The graph is pre-processed in accordance with to transform the raw node characteristics from the paper abstracts into node embeddings.

Wikipedia: This is a public dataset of Wikipedia edits. It includes the top 1000 pages with the most edits and 8227 users with at least 5 edits. User edits were converted into 172-dimensional LIWC feature vectors. The node feature was created by averaging each user's edit vectors.

Taobao: It is a large-scale online purchasing network on the e-commerce portal taobao.com. A temporal edge (u, v, t) denotes user u bought item v at time t. Node features contain preprocessed textual characteristics of a transaction.

The performance of the NodeTPP model is evaluated and compared against other static, temporal and TPP based graph representation baseline as follows:

Static graph representation methods: (1) DeepWalk: It uses random walks to generate node sequences, which are then treated as sentences to train a skip-gram model. The resulting embeddings capture the structural information and community structure of the network. (2) Node2vec: It uses biased random walks to learn latent representations of nodes. It learns node embeddings focused on local or global structure in the graph by varying the walk bias parameters and prioritizing between BFS and DFS. (3) VGAE: A graph representation framework that uses variational autoencoders to learn low-dimensional embeddings of graphs that capture structural and relational information. (4) GAE: It is a non-probabilistic graph auto-encoder version of the VGAE model. and (5) GraphSAGE: An inductive method that iteratively aggregates features from a node's local neighborhood using one of the four methods: GCN, mean, LSTM, and pool.

Temporal graph representation methods: (1) CTDNE: It uses continuous time random walks to model node transitions over time, uniting network structure and temporal dynamics into the embedding process for more accurate representation. (2) EvolveGCN: It introduces an approach to graph learning that evolves GCN parameters over time without using node embeddings, which allows it to handle graphs where the node sets at different time steps may completely differ. (3) GraphSAGE+T: It is a variant of GraphSAGE. It differs by concatenating a proposed time encoding to the features during temporal aggregations. (4) TGAT: It combines GNNs with harmonic analysis to capture both structural and temporal information. It also introduces a temporal kernel based on Boschner's theorem to capture the complex evolution. (5) TGN: It extends the prior methods by combining memory modules and graph-based operators to learn accurate and efficient representations. The memory module helps the model memorize node-wise long-term dependencies. (6) JODIE: It uses a shared RNN to update user and item embeddings in a recommendation system. It learns the mutual influence between users and items over time.

TPP-based (Hawkes-processes-based) approaches: (1) DyRep: It learns embeddings that capture the dynamics of communication and association between nodes. These dynamics evolve at different time scales. DyRep uses a time-scale dependent multivariate TPP model to capture them. (2) HTNE: This method uses Hawkes' process and attention mechanism to capture the influence caused by historical neighbors on the current neighbors of a node. (3) MMDNE: It uses both micro-dynamics (temporal patterns of individual nodes) and macro-dynamics (temporal patterns of the entire network) to get a comprehensive representation of temporal networks. (4) TREND: It learns the individual and collective properties of events by integrating both event and node dynamics. It is inductive as it uses Hawkes-process-based GNN architecture.

### Temporal Link Prediction

Task definition: A node with many interactions in the past will likely have more interactions in the future. The modeling of the influence of past events is crucial to learn the node's future interactions. The structural link might get formed between two highly interactive nodes as they will keep on interacting with others leading to interaction with themselves. To evaluate the model on this phenomenon, the standard task of temporal link prediction is evaluated. The model is evaluated based on its ability to predict the formation of new events (links). A given temporal graph dataset G is first split into train Iₜᵣ and test splits Iₜₑ. A point of split is an edge time t split such that past links in training are I tr={eᵢ=(xᵢ, yᵢ, tᵢ)∈E: t i≤t split} and future links in testing are Iₜₑ={eᵢ=(xᵢ, yᵢ, tᵢ)∈: tᵢ>t split}. The objective is to predict whether there is an edge between nodes x, y at time t>t split. As NodeTPP is GNN based inductive algorithm, it is capable of dealing with the nodes that are not part of the training. This downstream objective of link prediction is achieved by obtaining node representation from the pre-trained NodeTPP model and training a logistic regression classifier to classify event-edge into positive or negative classes. Note that the classifier is trained using only edge-events in testing Iₜₑ. It is achieved by splitting I te into the further train-test split of 80%-20%. Accuracy and F1 scores are used as evaluation metrics in the temporal link prediction task.

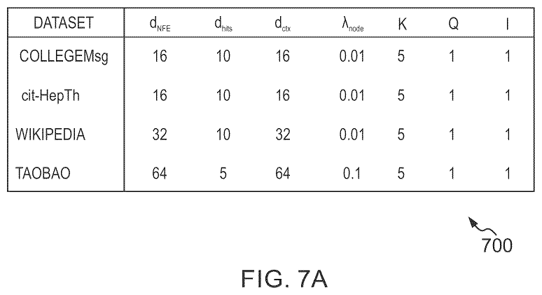

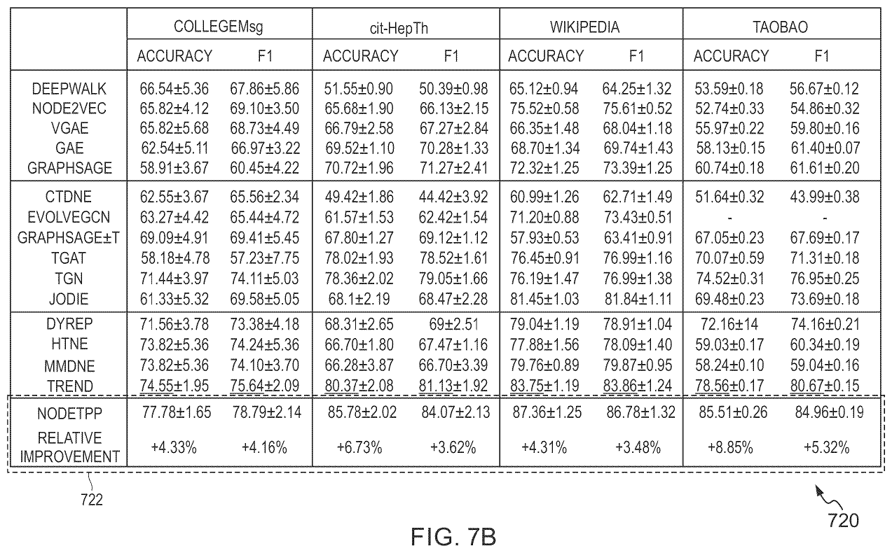

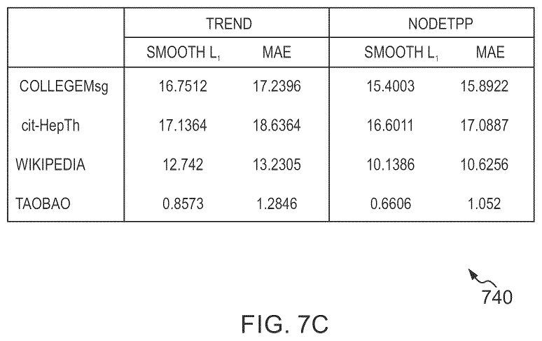

Model Training: For each dataset, the train split I tr is used for training. For a given incident edge sequence Eₓ, edge embeddings ei (FIG. 4A) are calculated and then intensities (see, FIG. 4B) are calculated. Later, using Eqn. 10, overall loss Lₓ is determined. This loss is minimized using Adam optimizer over mini-batches. The optimizer is configured with a learning rate of 1e−3 and weight decay of 1e−5. The early stopping with the patience of 50 is used. For a fair comparison, multiple sets of hyperparameters are used. The best values are shown in table 700 as shown in FIG. 7A. The table 700 includes parameters such as node feature extractor output d_{NFE}, event history context length is d_{ctx}, node coefficient is λ node, K is number of negative samples, Q is the number of time samples per negative samples in Algorithm 2 and l is number of GNN layers.

### Performance Evaluation

FIG. 7B shows a table 720 including comparative results of the performance of the NodeTPP model and the other comparative algorithms on the above-stated temporal task prediction task.

The trained models are evaluated on the temporal link prediction task. The downstream logistic regression classifier is trained on I^{te} with 80%-20% train-test split. The splitting over 10 times is repeated and average numbers along with the variation are shown in the table 720. The NodeTPP model outperforms other baselines by significant margins in both accuracy and F1 metrics. The significance of the results is established using a p-value-based two-tail t-test. In general, static models perform poorly, temporal models show average performance, and TPP-based models show superior performance. The NodeTPP model, being a flexible TPP model based on GNN, shows better performance compared to the rest. For the CollegeMsg dataset, the relative improvement of the NodeTPP model in terms of accuracy and F1 score is 4.33% and 4.16%. Similarly, the relative improvements of the NodeTPP model for other datasets are shown in the table 720 (see, 722).

The table 720 is divided into three sections based on static, temporal, and TPP-based methods. Static methods show inferior performance compared to others due to a lack of temporal information. Within static methods, DeepWalk and Node2vec are transductive and cannot deal with new nodes in the testing. On average, static inductive methods (VGAE, GAE, and GraphSAGE) show superior performance over static transductive methods DeepWalk and Node2vec. In temporal methods, it can be clearly observed a lift in performance over static methods. EvolveGCN, TGAT, and TGN are GNN-based methods. Note that EvolveGCN is a snapshot-based temporal graph modeling method that fails to model graph evolution across the snapshots. The methods like DyREP, HTNE, MMDNE, and TREND use Hawkes-process to model temporal event interactions. Among these, only TREND is inductive as it is GNN-based. TGAT and TGN perform competitively with the TPP-based methods. These methods show better performance on datasets cit-HepTh and Taobao compared to HTNE and MMDNE owing to their inductive ability.

In TPP-based methods, TREND uses Hawkes-process-based GNN along with Hypernetwork and FILM modules for modeling. Due to this, it shows the best performance compared to other Hawkes-process-based methods. As methods developed using Hawkes-process suffer from the inherent problem of model misspecification, they are not optimal. The NodeTPP model is derived from flexible TPP-based GNN and it outperforms previous Hawkes-process-based methods. Node dynamics play a crucial role in learning temporal graph representation and temporal link prediction. The overall training objective involves a loss term (L_{x,t}^{node} in Eqn. 11) based on node dynamics. It is evaluated separately using smooth L1 loss and mean absolute error (MAE) as evaluation metrics. The results are shown in FIG. 7C compared to the previous best baseline TREND (See, 740). In NodeTPP, flexible TPP formulation plays a key role over TREND's Hawkes-process-based formulation. The TREND optimizes intensity of edges and does not benefit from more negative edges.

### Analysis and Discussion

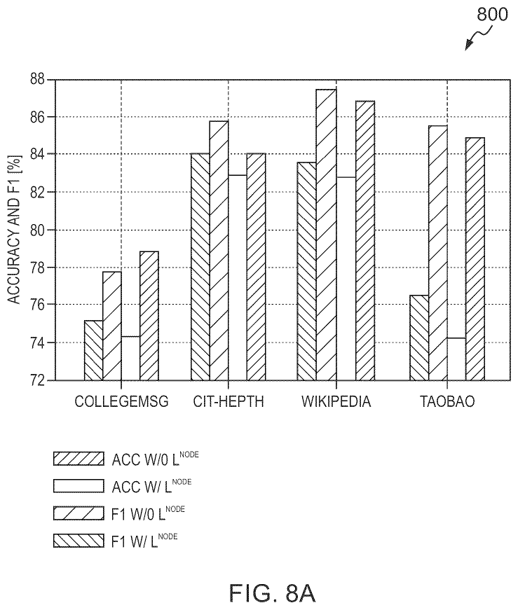

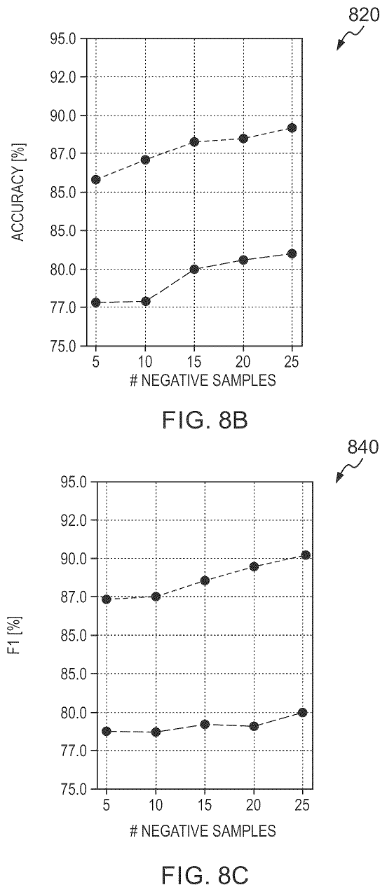

FIGS. 8A-8C depict an ablation study of the NodeTPP model by comparing the NodeTPP model with baseline models.

Ablation Study: The node dynamic loss L^{node} in Equation 10 helps in improving node embeddings, leading to better performance on temporal link prediction tasks. The NodeTPP models for each dataset use node dynamics loss in training. FIG. 8A shows a study of the impact of L^{node} on temporal link prediction using accuracy and F1 score metrics (see, 800). While optimizing Lₓ^{surv} (i.e., second term) in Equation 9, the Monte Carlo trick described in Algorithm 2 uses negative samples denoted by K. FIG. 8B shows model performance with respect to K. In other words, FIG. 8B and FIG. 8C are charts 820 and 840 to show the impact of negative samples on temporal link prediction. On CollegeMsg and cit-HepTH, it can be seen that accuracy and F1 metrics improve with an increase in K. More negative samples provide a better estimate of the integral in Equation 9 by reducing the variance of the estimator. However, it requires more computations (Algorithm 2). Previous Hawkes-process-based methods do not show improvement in the metrics with an increase in the number of negative samples.

In fact, in TREND performance degrades for some datasets with an increase in K. Thus, NodeTPP is capable of leveraging additional negative samples during training to improve the quality of positive node embeddings.

Embodiments of the present disclosure provide a number of advantages. For example, experimental results on a number of graph datasets indicate a significant margin of gains over several recently proposed methods. The evaluation results show that embodiments of the present disclosure achieve significant improvements over several state-of-the-art baselines and maintain a more stable performance in learning node representations for temporal graphs that directly capture both structural and relational properties between the nodes. The present disclosure overcomes prior Hawkes-process-based model misspecification shortcomings by introducing a flexible TPP-based method, NodeTPP, on top of inductive GNN. The NodeTPP model learns edge-contextualized node embeddings leading to the capture of complex non-linear event dynamics in the temporal graphs. The model is trained on standard NLL objectives over the edge sequence and node dynamics to model the node embedding evolution. The NodeTPP model is evaluated on the downstream task of temporal link prediction against static, temporal, and Hawkes-process-based TPP baselines. Extensive experimentation on four diverse real-world datasets highlights the merits of the NodeTPP model.

The disclosed methods with reference to FIGS. 1A to 8A-8C, or one or more operations of the methods 500 and 600 may be implemented using software including computer-executable instructions stored on one or more computer-readable media (e.g., non-transitory computer-readable media, such as one or more optical media discs, volatile memory components (e.g., DRAM or SRAM), or nonvolatile memory or storage components (e.g., hard drives or solid-state nonvolatile memory components, such as Flash memory components) and executed on a computer (e.g., any suitable computer, such as a laptop computer, netbook, Web-book, tablet computing device, smartphone, or other mobile computing devices). Such software may be executed, for example, on a single local computer or in a network environment (e.g., via the Internet, a wide-area network, a local-area network, a remote web-based server, a client-server network (such as a cloud computing network), or other such networks) using one or more network computers. Additionally, any of the intermediate or final data created and used during the implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

Although the disclosure has been described with reference to specific exemplary embodiments, it is noted that various modifications and changes may be made to these embodiments without departing from the broad spirit and scope of the disclosure. For example, the various operations, blocks, etc. described herein may be enabled and operated using hardware circuitry (for example, complementary metal-oxide-semiconductor (CMOS) based logic circuitry), firmware, software, and/or any combination of hardware, firmware, and/or software (for example, embodied in a machine-readable medium). For example, the apparatuses and methods may be embodied using transistors, logic gates, and electrical circuits (for example, application-specific integrated circuit (ASIC) circuitry and/or in Digital Signal Processor (DSP) circuitry).

Particularly, the server system 200 (e.g., the server system 102 or the server system 122) and its various components such as the computer system 202 and the database 204 may be enabled using software and/or using transistors, logic gates, and electrical circuits (for example, integrated circuit circuitry such as ASIC circuitry). Various embodiments of the disclosure may include one or more computer programs stored or otherwise embodied on a computer-readable medium, wherein the computer programs are configured to cause a processor or computer to perform one or more operations. A computer-readable medium storing, embodying, or encoded with a computer program, or similar language may be embodied as a tangible data storage device storing one or more software programs that are configured to cause a processor or computer to perform one or more operations. Such operations may be, for example, any of the steps or operations described herein. In some embodiments, the computer programs may be stored and provided to a computer using any type of non-transitory computer-readable media. Non-transitory computer-readable media include any type of tangible storage media. Examples of non-transitory computer-readable media include magnetic storage media (such as floppy disks, magnetic tapes, hard disk drives, etc.), optical magnetic storage media (e.g., magneto-optical disks), CD-ROM (compact disc read-only memory), CD-R (compact disc recordable), CD-R/W (compact disc rewritable), DVD (Digital Versatile Disc), BD (BLU-RAY® Disc), and semiconductor memories (such as mask ROM, PROM (programmable ROM), EPROM (erasable PROM), flash memory, RAM (random access memory), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer-readable media. Examples of transitory computer-readable media include electric signals, optical signals, and electromagnetic waves. Transitory computer-readable media can provide the program to a computer via a wired communication line (e.g., electric wires, and optical fibers) or a wireless communication line.

Various embodiments of the invention, as discussed above, may be practiced with steps and/or operations in a different order, and/or with hardware elements in configurations, which are different than those which are disclosed. Therefore, although the invention has been described based upon these exemplary embodiments, it is noted that certain modifications, variations, and alternative constructions may be apparent and well within the spirit and scope of the invention.

Although various exemplary embodiments of the invention are described herein in a language specific to structural features and/or methodological acts, the subject matter defined in the appended claims is not necessarily limited to the specific features or acts described above. Rather, the specific features and acts described above are disclosed as exemplary forms of implementing the claims.

We claim:

1. A computer-implemented method, comprising:
accessing, by a server system, historical interaction data comprising a plurality of interactions among a plurality of entities from a database;
generating, by the server system, a temporal graph based, at least in part, on the historical interaction data, the temporal graph representing a computer-based graph representation of the plurality of entities as nodes and time-ordered event sequences between nodes as temporal edges;
predicting, by the server system, likelihoods of future interaction occurrences among the plurality of entities based, at least in part, on a pre-trained temporal point process (TPP) based graph neural network (GNN) model, the likelihoods of the future interaction occurrences determined by executing a plurality of operations for each node in a graph traversal manner, the plurality of operations comprising:
determining, by the server system, a plurality of edge embeddings associated with a node based, at least in part, on node features of the node and a plurality of direct neighbor nodes of the node;
generating, by the server system, edge-contextualized node embeddings of the node corresponding to the plurality of edge embeddings based, at least in part, on a neural network model; and
computing, by the server system, a likelihood of future interaction occurrences associated with the node based, at least in part, on the edge-contextualized node embeddings and a conditional intensity function; and
executing, by the server system, at least one of a plurality of graph context prediction tasks based, at least in part, on the likelihoods of future interaction occurrences among the plurality of entities.

2. The computer-implemented method as claimed in claim 1, wherein computing the likelihood of future interaction occurrences associated with the node further comprises:
calculating, by the server system, a conditional intensity for each edge of the node based, at least in part, on the edge-contextualized node embedding of the node; and
calculating, by the server system, a likelihood function based, at least in part, on the conditional intensity of each edge, wherein the likelihood function is conditioned on edges of the node.

3. The computer-implemented method as claimed in claim 1, wherein the plurality of operations further comprises:
concatenating, by the server system, the node features of the node and the plurality of direct neighbor nodes of the node based, at least in part, on times of interactions between the node and the plurality of direct neighbor nodes.

4. The computer-implemented method as claimed in claim 1, wherein the neural network model represents a recurrent neural network model.

5. The computer-implemented method as claimed in claim 1, wherein the TPP based GNN model is trained based, at least in part, on a combination of a first loss value and a second loss value at node-level.

6. The computer-implemented method as claimed in claim 5, wherein the first loss value is based, at least in part, on negative log-likelihood (NLL) of a likelihood function determined based on conditional intensity of each edge.

7. The computer-implemented method as claimed in claim 5, wherein the second loss value is based, at least in part, on node dynamics loss, and wherein the node dynamics loss is determined based on smooth L1 loss.

8. The computer-implemented method as claimed in claim 1, wherein the plurality of entities comprises a first set of entities and a second set of entities, the first set of entities including a plurality of cardholders and the second set of entities including a plurality of merchants.

9. The computer-implemented method as claimed in claim 1, wherein the plurality of graph context prediction tasks comprises at least one of: (a) transaction anomaly detection, (b) dynamic edge prediction between cardholder and merchant, and (c) anti-money laundering.

10. A server system, comprising:
a communication interface;
a memory comprising executable instructions; and
a processor communicably coupled to the communication interface and the memory, the processor configured to cause the server system to at least:
access historical interaction data comprising a plurality of interactions among a plurality of entities from a database;
generate a temporal graph based, at least in part, on the historical interaction data, the temporal graph representing a computer-based graph representation of the plurality of entities as nodes and time-ordered event sequences between nodes as temporal edges;
predict likelihoods of future interaction occurrences among the plurality of entities based, at least in part, on a pre-trained temporal point process (TPP) based graph neural network (GNN) model, the likelihoods of the future interaction occurrences determined by executing a plurality of operations for each node in a graph traversal manner, the plurality of operations comprising:
determine a plurality of edge embeddings associated with a node based, at least in part, on node features of the node and a plurality of direct neighbor nodes of the node;
generate edge-contextualized node embeddings of the node corresponding to the plurality of edge embeddings based, at least in part, on a neural network model; and
compute a likelihood of future interaction occurrences associated with the node based, at least in part, on the edge-contextualized node embeddings and a conditional intensity function; and
execute at least one of a plurality of graph context prediction tasks based, at least in part, on the likelihoods of future interaction occurrences among the plurality of entities.

11. The server system as claimed in claim 10, wherein the server system is further caused, at least in part, to:
calculate a conditional intensity for each edge of the node based, at least in part, on the edge-contextualized node embedding of the node; and
calculate a likelihood function based, at least in part, on the conditional intensity of each edge, wherein the likelihood function is conditioned on edges of the node.

12. The server system as claimed in claim 10, wherein the server system is further caused, at least in part, to:
concatenate the node features of the node and the plurality of direct neighbor nodes of the node based, at least in part, on times of interactions between the node and the plurality of direct neighbor nodes.

13. The server system method as claimed in claim 10, wherein the neural network model represents a recurrent neural network model.

14. The server system as claimed in claim 10, wherein the TPP based GNN model is trained based, at least in part, on a combination of a first loss value and a second loss value at node-level.

15. The server system as claimed in claim 14, wherein the first loss value is based, at least in part, on negative log-likelihood (NLL) of a likelihood function determined based on conditional intensity of each edge.

16. The server system as claimed in claim 14, wherein the second loss value is based, at least in part, on a node dynamics loss, and wherein the node dynamics loss is determined based on smooth L1 loss.

17. The server system as claimed in claim 10, wherein the plurality of entities comprises a first set of entities and a second set of entities, the first set of entities including a plurality of cardholders and the second set of entities including a plurality of merchants.

18. The server system as claimed in claim 10, wherein the plurality of graph context prediction tasks comprises at least one of: (a) transaction anomaly detection, (b) dynamic edge prediction between cardholder and merchant, and (c) anti-money laundering.

19. A non-transitory computer-readable storage medium comprising computer-executable instructions that, when executed by at least a processor of a server system, cause the server system to perform a method comprising:
accessing historical interaction data comprising a plurality of interactions among a plurality of entities from a database;
generating a temporal graph based, at least in part, on the historical interaction data, the temporal graph representing a computer-based graph representation of the plurality of entities as nodes and time-ordered event sequences between nodes as temporal edges;
predicting likelihoods of future interaction occurrences among the plurality of entities based, at least in part, on a pre-trained temporal point process (TPP) based graph neural network (GNN) model, the likelihoods of the future interaction occurrences determined by executing a plurality of operations for each node in a graph traversal manner, the plurality of operations comprising:
determining a plurality of edge embeddings associated with a node based, at least in part, on node features of the node and a plurality of direct neighbor nodes of the node;
generating edge-contextualized node embeddings of the node corresponding to the plurality of edge embeddings based, at least in part, on a neural network model; and
computing a likelihood of future interaction occurrences associated with the node based, at least in part, on the edge-contextualized node embeddings and a conditional intensity function; and
executing at least one of a plurality of graph context prediction tasks based, at least in part, on the likelihoods of future interaction occurrences among the plurality of entities.

20. The non-transitory computer-readable storage medium as claimed in claim 19, wherein the plurality of entities comprises a first set of entities and a second set of entities, the first set of entities including a plurality of cardholders and the second set of entities including a plurality of merchants.
